(19) United States
(12) Patent Application Publication
(10) Pub. No.: US 2016/0328673 A1
(43) Pub. Date: Nov. 10, 2016

(54) SYSTEM AND METHOD FOR COUPLING ASSET MANAGEMENT AND ANALYTICS

(71) Applicant: General Electric Company, Schenectady, NY (US)

(72) Inventors: Jeanette Marie Bruno, Saratoga, NY (US); Segar Soundiramourthy, Pleasanton, CA (US); Tun Tun Min Chang, San Ramon, CA (US); Allen Chia-Yuan Chu, Dublin, CA (US)

(21) Appl. No.: 14/706,746

(22) Filed: May 7, 2015

(51) Int. Cl. G06Q 10/08; G06Q 10/06

(52) U.S. Cl. CPC G06Q 10/087; G06Q 10/0631

(57) ABSTRACT

A system and method for coupling asset management and analytics are disclosed. The method includes accessing a first asset management system storing corresponding asset data in a corresponding one of a first plurality of management data fields for each one of a first plurality of assets, identifying one of the first plurality of management data fields based on the corresponding language construct of the determined management data field, generating a first reference to the identified one of the first plurality of management data fields, and providing the first reference to the first analytics platform for use by the first analytics platform in retrieving the corresponding asset data of the identified management data field for use in a first analytics operation of the first analytics platform.

### TECHNICAL FIELD

The present application relates generally to the technical field of data processing, and, in various embodiments, to a system and method for coupling asset management and analytics.

### BACKGROUND

Current asset management and analytics systems lack flexibility in accommodating different functionalities and scalability. The burden of bridging the gap between an asset management system and an analytics system is placed on the users, requiring the users to actively make specific correlations between the two and manually define specific data models for use in the analytics system, resulting in significant inefficiencies, inaccuracies, and expense.

### BRIEF DESCRIPTION

Some or all of the above needs or problems may be addressed by one or more example embodiments. Example embodiments of a system and method for coupling asset management and analytics are disclosed.

In one example embodiment, a computer-implemented method comprises accessing a first asset management system. The first asset management system can store corresponding asset data for each one of a first plurality of assets, with each corresponding asset data being stored in a corresponding one of a first plurality of management data fields, and each one of the first plurality of management data fields having a corresponding language construct. The method can further comprise identifying, or otherwise determining, one of the first plurality of management data fields based on the corresponding language construct of the identified one of the first plurality of management data fields, generating a first reference to the identified one of the first plurality of management data fields based on the identifying of the one of the first plurality of management data fields, and providing the first reference to a first analytics platform for use by the first analytics platform in retrieving the corresponding asset data of the identified one of the first plurality of management data fields for use in a first analytics operation of the first analytics platform.

The above and other features, including various novel details of implementation and combination of events, will now be more particularly described with reference to the accompanying figures and pointed out in the claims. It will be understood that the particular techniques, methods, and other features described herein are shown by way of illustration only and not as limitations. As will be understood by those skilled in the art, the principles and features described herein may be employed in various and numerous embodiments without departing from the scope of the present disclosure.

### BRIEF DESCRIPTION OF THE DRAWINGS

Some embodiments of the present disclosure are illustrated by way of example and not limitation in the figures of the accompanying drawings, in which like reference numbers indicate similar elements, and in which:

FIG. 1 is a block diagram illustrating an environment in which one or more asset management systems are coupled to one or more analytics platforms by a coupling system, in accordance with some example embodiments;

FIG. 2 illustrates a graphical user interface (GUI) displaying asset classifications, in accordance with some example embodiments;

FIG. 3 illustrates a GUI displaying an asset composition hierarchy structure, in accordance with some example embodiments;

FIG. 4 illustrates a GUI displaying asset attributes, in accordance with some example embodiments;

FIG. 5 is a block diagram illustrating components of a coupling system, in accordance with some example embodiments;

FIG. 6 is a flowchart illustrating a method, in accordance with some example embodiments, for coupling an asset management system with an analytics platform;

FIG. 7 illustrates a GUI of an asset management system displaying asset classifications, in accordance with some example embodiments;

FIG. 8 illustrates a GUI of an analytics platform displaying an asset grouping field configured to enable a user to group assets by classification, in accordance with some example embodiments;

FIG. 9 illustrates a GUI of an asset management system displaying an asset classification having an attribute, in accordance with some example embodiments;

FIG. 10 illustrates a GUI of an analytics platform displaying enumerated attribute values carried forward from an asset management system based on an asset group being created, in accordance with some example embodiments;

FIG. 11 illustrates a GUI of an asset management system displaying non-enumerable attribute fields, in accordance with some example embodiments;

FIG. 12 illustrates a GUI of an analytics platform displaying an attribute value defined in an asset management system as part of an input/output mapping of an analytics operation, showing fields from the asset management system being carried forward into the analytics platform, in accordance with some example embodiments;

FIG. 13 illustrates a GUI of an asset management system displaying meters to be used in defining the nature of time series data, in accordance with some example embodiments;

FIG. 14 illustrates a GUI of an asset management system being used to associate meters with an asset, in accordance with some example embodiments;

FIG. 15 illustrates a GUI of an analytics platform displaying the availability in the analytics platform of a meter key defined in an asset management system, where fields from the asset management system have been carried forward into the analytics platform, in accordance with some example embodiments;

FIG. 16 is a block diagram illustrating a mobile device, in accordance with some example embodiments; and

FIG. 17 is a block diagram of an example computer system on which methodologies described herein can be executed, in accordance with some example embodiments.

The figures are not necessarily drawn to scale, and elements of similar structures or functions are generally represented by like reference numerals for illustrative purposes throughout the figures. The figures are only intended to facilitate the description of the various embodiments described herein. The figures do not describe every aspect of the teachings disclosed herein and do not limit the scope of the claims.

### DETAILED DESCRIPTION

Example systems and methods of coupling asset management and analytics are disclosed. In the following description, for purposes of explanation, numerous specific details are set forth in order to provide a thorough understanding of example embodiments. It will be evident, however, to one skilled in the art that the present embodiments can be practiced without these specific details.

In one example embodiment, a computer-implemented method comprises accessing a first asset management system. The first asset management system can store corresponding asset data for each one of a first plurality of assets, with each corresponding asset data being stored in a corresponding one of a first plurality of management data fields, and each one of the first plurality of management data fields having a corresponding language construct. The method can further comprise identifying, or otherwise determining, one of the first plurality of management data fields based on the corresponding language construct of the identified one of the first plurality of management data fields, generating a first reference to the identified one of the first plurality of management data fields based on the identifying of the one of the first plurality of management data fields, and providing the first reference to a first analytics platform for use by the first analytics platform in retrieving the corresponding asset data of the identified one of the first plurality of management data fields for use in a first analytics operation of the first analytics platform.

In some example embodiments, the method further comprises causing an auto-population of a selectable graphical user interface (GUI) element of the first analytics platform with the corresponding asset data of the identified one of the first plurality of management data fields based on the first reference, enabling a user to select the identified one of the first plurality of management data fields for use in the first analytics operation of the first analytics platform.

In some example embodiments, the first reference is configured to be used to modify a value of the identified one of the first plurality of management data fields based on output data of the first analytics operation.

In some example embodiments, the method further comprises receiving an indication that the first asset management system has been updated, wherein the identifying and the generating are performed based on the indication.

In some example embodiments, the method further comprises accessing a second asset management system distinct from the first asset management system. The second asset management system can store corresponding asset data for each one of a second plurality of assets, with each corresponding asset data being stored in a corresponding one of a second plurality of management data fields, and each one of the second plurality of management data fields having a corresponding language construct. The method can further comprise identifying one of the second plurality of management data fields based on the corresponding language construct of the identified one of the second plurality of management data fields, generating a second reference to the identified one of the second plurality of management data fields based on the identifying of the one of the second plurality of management data fields, and providing the second reference to the first analytics platform for use by the first analytics platform in retrieving the corresponding asset data of the identified one of the second plurality of management data fields for use in the first analytics operation of the first analytics platform.

In some example embodiments, the method further comprises identifying another one of the first plurality of management data fields based on the corresponding language construct of the other one of the first plurality of management data fields, generating a second reference to the identified one of the first plurality of management data fields based on the identifying of the other one of the first plurality of management data fields, and providing the second reference to a second analytics platform for use by the second analytics platform in retrieving the corresponding asset data of the identified other one of the first plurality of management data fields for use in a second analytics operation of the second analytics platform.

In some example embodiments, each of the corresponding asset data comprises at least one of classification data of the corresponding one of the first plurality of assets, hierarchy data of the corresponding one of the first plurality of assets, and attribute data of the corresponding one of the first plurality of assets. In some example embodiments, the classification data is used to derive an analytics field for the first analytics platform, the analytics field indicating a classification of the corresponding asset of the identified one of the first plurality of management data fields. In some example embodiments, the hierarchy data is used to derive an analytics field for the first analytics platform, the analytics field indicating what is the corresponding asset of the identified one of the first plurality of management data fields or one or more components of the corresponding asset of the identified one of the first plurality of management data field.

Alternative embodiments other than the embodiments discussed above are also within the scope of the present disclosure, some examples of which are also provided in the present disclosure.

Some technical effects of the system and method of the present disclosure are to automatically generate a mapping of data from an asset management system to an analytics platform without a user having to define a data model in the analytics platform. Other technical effects of the system and method of the present disclosure are to provide the ability to form many-to-many associations between a group of asset management systems and a group of analytics platforms, providing flexibility in architecting a complex system with different functionalities and providing ability in architecting a large-scale system. Additionally, other technical effects will be apparent from this disclosure as well.

The methods or embodiments disclosed herein may be implemented as a computer system having one or more modules (e.g., hardware modules or software modules). Such modules may be executed by one or more processors of the computer system. In some embodiments, a non-transitory machine-readable storage device can store a set of instructions that, when executed by at least one processor, causes the at least one processor to perform the operations and method steps discussed within the present disclosure.

In the description below, for purposes of explanation only, specific nomenclature is set forth to provide a thorough understanding of the present disclosure. However, it will be apparent to one skilled in the art that these specific details are not required to practice the teachings of the present disclosure.

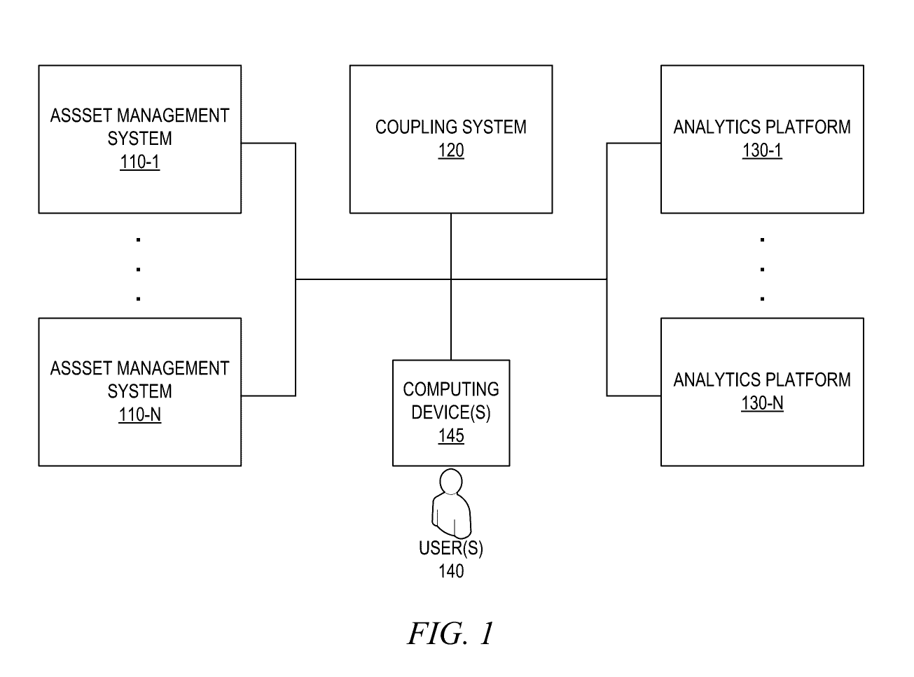

FIG. 1 is a block diagram illustrating an environment in which one or more asset management systems 110 (e.g., asset management system 110-1, . . . , asset management system 110-N) are coupled to one or more analytics platforms 130 (e.g., analytics platform 130-1, . . . , analytics platform 130-N) by a coupling system 120, in accordance with some example embodiments. One or more users 140 can access and use the functionality (e.g., request the performance of operations) of the asset management system(s) 110, the coupling system 120, and the analytics platform(s) 130 via one or more of their corresponding computing devices 145. Examples of computing devices 145 include, but are not limited to, desktop computers, laptop computers, tablet computers, smartphones, and other mobile devices.

The communication (e.g., transmission) of data between systems, platforms, modules, databases, users, devices, and machines disclosed herein can be achieved via communication over one or more networks. Accordingly, the asset management system(s) 110, the coupling system 120, the analytics platform(s) 130, and the computing device(s) 145 can be part of a network-based system. The network may be any network that enables communication between or among systems, modules, databases, devices, and machines. Accordingly, the network may be a wired network, a wireless network (e.g., a mobile or cellular network), or any suitable combination thereof. The network may include one or more portions that constitute a private network, a public network (e.g., the Internet), or any suitable combination thereof.

The coupling system 120 is configured to provide tight coupling between the asset management system(s) 110 and the analytics platform(s) 130, thereby enabling the analytics operations to run on the analytics platform(s) 130 using the data residing in the asset management system(s) 110.

In some example embodiments, an asset management system 110 is configured to manage asset data. In some example embodiments, an asset comprises property owned or controlled by a person, company, organization, or other entity. Assets within the scope of the present disclosure can include, but are not limited to, physical tangible assets and digital assets. Examples of assets include, but are not limited to, equipment, people, and contracts. Other types of assets are also within the scope of the present disclosure. In some example embodiments, asset data comprises any combination of one or more of an identifier (e.g., name, identification number) of the corresponding asset and metadata of the corresponding asset. The metadata of the asset can comprise any combination of one or more of classification data, hierarchy data, and attribute data.

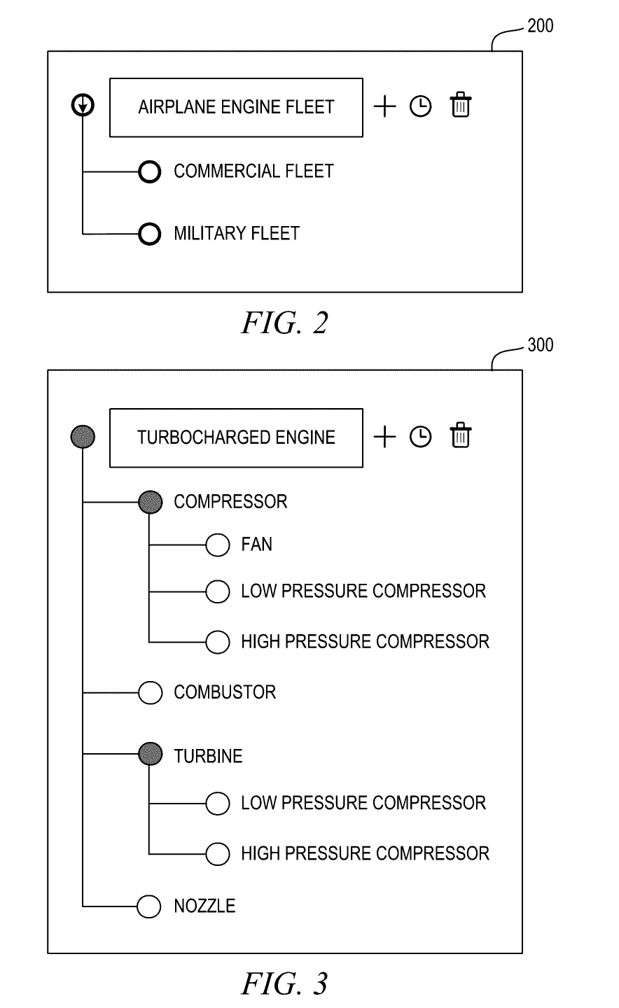

FIG. 2 illustrates a graphical user interface (GUI) 200 displaying asset classifications, in accordance with some example embodiments. A classification provides a way to arrange assets in groups or categories according to established criteria. In the example embodiment of FIG. 2, a company owns or controls a fleet of airplane engines, which are considered assets of the company. GUI 200 displays two types of classifications for these assets—“commercial fleet” for commercial aircrafts and “military fleet” for military aircrafts.

FIG. 3 illustrates a GUI 300 displaying an asset composition hierarchy structure, in accordance with some example embodiments. The hierarchy data is configured to indicate a hierarchical parts composition structure for the corresponding asset. In the example embodiment of FIG. 3, a turbocharged engine is shown as being an asset. The turbocharged engine is made up of many major components, such as a compressor, a combustor, a turbine, and a nozzle. These major components may comprise many subcomponents, and the subcomponents can be broken down into even further subcomponents, all the way to nuts and bolts. The subcomponents of an asset can also be considered, identified, and treated as assets themselves. In an example embodiment of a company having two types of airplane engines—turbocharged engines and supercharged engines—these two types of engines may contain different parts. The makeup of these two types of engines can be captured as two different asset composition hierarchy structures.

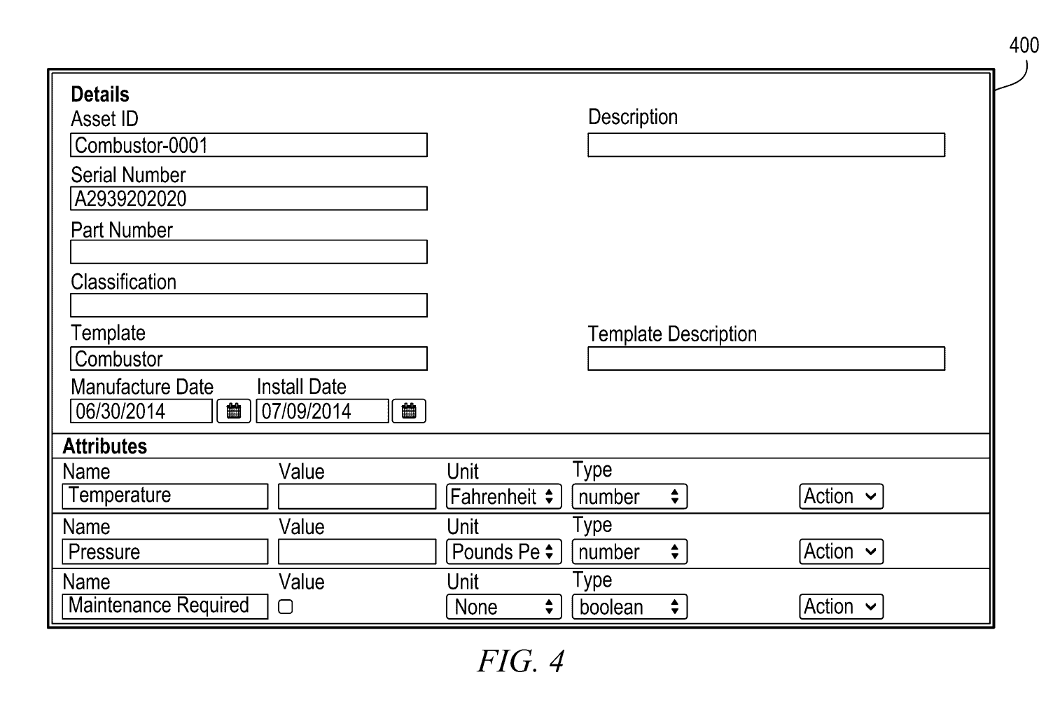

FIG. 4 illustrates a GUI 400 displaying asset attributes, in accordance with some example embodiments. In some example embodiments, the attribute data can comprise information indicating a condition or status of an asset. In the example embodiment of FIG. 4, a combustor asset (Combuster-0001) comprises three attributes—temperature, pressure, and a maintenance required flag—each having corresponding attribute data, such as value, unit, and type.

Referring back to FIG. 1, in some example embodiments, the analytics platform(s) 130 comprises a computing platform configured to configure and execute analytics, enabling the discovery, generation, and communication of patterns in data with respect to the data of the asset management system(s) 110.

At run time, the analytics platform 130 fetches asset data of a group of assets from the asset management system(s) 110 and runs a sequence of analytics for each asset using the asset data. In one example embodiment, a user 140 may want to run a specific combustor monitoring analytics for the combustors contained in the turbocharged engines that belong to a commercial fleet. The analytics platform 130 can retrieve a series of temperature and pressure data (e.g., readings) for each combustor and determine whether maintenance is required or not based on the data. First, the analytics platform 130 retrieves asset data for a group of assets that are of type “combustor” that are contained in the turbocharged engines and that belong to the commercial fleet. Then, the analytics platform 130 performs the analytics operation(s) for each combustor in the group with the input/output specific to each combustor.

The following table illustrates an example embodiment of criteria that can be used by the analytics platform 130 to retrieve the intended group of assets:

| Criteria | Value |
|---|---|
| Asset is a | Combustor |
| Asset is a descendent of | Turbocharged Engine |
| Asset belongs to type | Commercial Fleet |

The following table illustrates the input and output of the combustor monitoring analytics operation(s):

| Input | Output |
|---|---|
| Temperature readings | Maintenance Required flag |
| Pressure readings | |

As previously discussed, the coupling system 120 is configured to provide tight coupling between the asset management system(s) 110 and the analytics platform(s) 130, thereby enabling the analytics operations to run on the analytics platform(s) 130 using the data residing in the asset management system(s) 110. In some example embodiments, tight coupling between an asset management system 110 and an analytics platform 130 comprises the mapping of data from the asset management system 110 to the analytics platform 130. The mapping can include, but is not limited to, two types of mapping. The first mapping enables the analytics platform 130 to configure and retrieve groups of assets. The second mapping enables the analytics platform 130 to retrieve the data from the asset management system 110 as input data for running analytics operations. The second mapping also enables the analytics platform 130 to store the output data from the analytics operations in the asset management system 110.

In some example embodiments, the coupling system 120 is configured to expose the constructs and the data point fields available in the asset management system(s) 110 to the analytics platform(s) 130. One type of field that can be mapped from the asset management system(s) 110 and made available to the analytics platform(s) 130 is for asset grouping, and another type of field is for input/output of the analytics. In some example embodiment, the asset grouping fields are also available for input/output of the analytics. The mapping can be added as needed based on the features and capabilities of the asset management system(s) 110 and the analytics platform(s) 130.

The following table illustrates an example embodiment of mapping based on the example described above:

| Asset Metadata Model | Mapped Field | Mapped Field Type |
|---|---|---|
| Nodes of asset hierarchy | Asset is a | Asset Grouping Field |
| structure | | |
| Parent/child relationship | Asset is a | Asset Grouping Filed |
| between nodes of asset | descendent of | |
| hierarchy structure | | |
| Nodes of asset | Asset is of type | Asset Grouping Field |
| classification | | |
| Parent/child relationship | Asset belongs to type | Asset Grouping Field |
| between nodes of asset | | |
| classification | | |
| Asset attributes | Asset data | Input/Output Field |

In some example embodiments, a technical solution of the present disclosure provides an ability to run analytics operations on an analytics platform 130 with the data residing in a separate asset management system 110. By configuring an asset management system 110 and an analytics platform 130 as two separate systems, and by providing a tight coupling layer between them in the form of the coupling system 120, many-to-many associations can be formed between a group of asset management systems 110 and a group of analytics platforms 130. That is, on a particular analytics platform 130, analytics operations can be run with multiple asset management systems 110 as their data sources. Conversely, a particular asset management system 110 can serve as the data source for multiple analytic platforms 130.

Given a generalized asset management system 110, a generalized analytics platform 130, and a coupling system 120 in between, the asset management system 110 can be utilized to manage different types of asset data. Then, different types of analytics operations can be developed, configured, and executed with the data residing in asset management system 110. The ability to form many-to-many associations between a group of asset management systems 110 and a group of analytics platforms 130 provides flexibility in architecting a complex system with different functionalities and provides ability in architecting a large-scale system.

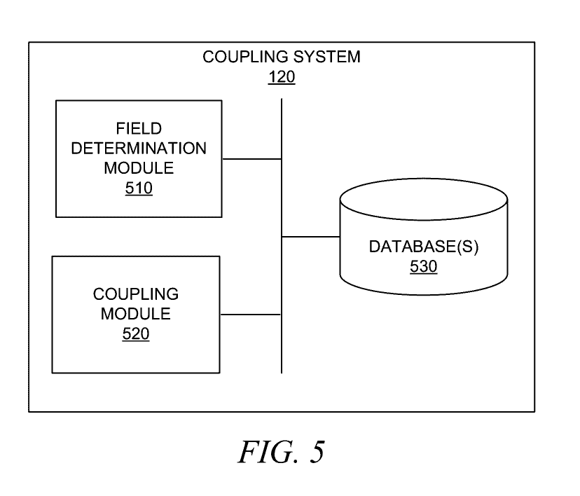

FIG. 5 is a block diagram illustrating components of the coupling system 120, in accordance with some example embodiments. In some example embodiments, the coupling system 120 comprises any combination of one or more of a field determination module 510 and a coupling module 520. The coupling system 120 can also comprise one or more databases 530. The field determination module 510, the coupling module 520, and the database(s) 530 can be communicatively coupled to each other, and can reside on a machine having a memory and at least one processor (not shown). These components of the coupling system 120 can also reside on separate machines.

In some example embodiments, the field determination module 510 is configured to access an asset management system 110. As previously discussed, the asset management system 110 can store corresponding asset data for each one of a corresponding plurality of assets. Each corresponding asset data can be stored in a corresponding one of a plurality of management data fields, and each one of the plurality of management data fields can have a corresponding language construct.

In some example embodiments, each of the corresponding asset data comprises at least one of classification data of the corresponding one of the plurality of assets (e.g., as discussed above with respect to FIG. 2), hierarchy data of the corresponding one of the plurality of assets (e.g., as discussed above with respect to FIG. 3), and attribute data of the corresponding one of the plurality of assets (e.g., as discussed above with respect to FIG. 4).

In some example embodiments, the field determination module 510 is further configured to determine that one of the plurality of management data fields can be or is to be used as an analytic data field in an analytics operation of an analytics platform 130 based on the corresponding language construct of that management data field. In some example embodiments, the field determination module 510 is configured to identify, or otherwise determine, one of the management data fields based on the corresponding language construct of that management data field. In this respect, one or more of the management data fields of the asset management system 110 can be used to derive one or more analytic data fields for the analytics platform 130.

For example, one of the management data fields can be a field for classification data and have a corresponding language construct of “isClass”, which can be determined by the field determination module 510 to be used as an asset data field in the analytics platform 130 configured to enable grouping of assets based on their classification (e.g., an asset grouping field). Other examples are also within the scope of the present disclosure.

In some example embodiments, the coupling module 520 is configured to generate a reference to the identified management data field based on the identifying of the management data field, and to provide the reference to an one or more analytics platforms 130 for use by the analytics platform(s) 130 in retrieving the corresponding asset data of the identified management data field for use in one or more analytics operations of the analytics platform(s) 130. The coupling module 520 can provide the reference to the analytics platform 130 in a variety of ways, including, but not limited to, transmitting the reference to the analytics platform 130 or allowing the analytics platform 130 to access the reference stored on the coupling system 120.

It is contemplated that the analytics platform 130 can use the generated reference in an analytics operation in a variety of ways. In some example embodiments, the reference is configured to be used by the analytics platform 130 to auto-populate a selectable GUI element (e.g., a drop-down menu) of the analytics platform 130 with the corresponding asset data of the referenced management data field, enabling a user 140 to select the corresponding asset data of the determined management data field for use in an analytics operation of the analytics platform 130 without the user having to manually create a mapping between the fields. In some example embodiments, the reference is configured to be used by any combination of one or more of the asset management system(s) 110, the coupling module 520, or the analytics platform(s) 130 to modify a value of the identified management data field based on output data of the analytics operation, updating the asset management system 110 without the user 140 having to manually enter or submit the output data into the asset management system 110.

In some example embodiments, the field determination module 510 or the coupling module 520 is configured to receive an indication that the asset management system 110 has been updated. The field determination module 510 can be configured to identify the management data field of the asset management system 110 in response to, or otherwise based on, the indication. The coupling module 520 can be configured to generate the reference in response to, or otherwise based on, the indication.

In some example embodiments, the field determination module 510 is configured to access multiple asset management systems 110, each storing corresponding asset data for each one of a corresponding plurality of assets, with each corresponding asset data being stored in a corresponding one of a second plurality of management data fields, and each one of the plurality of management data fields having a corresponding language construct. The coupling module 520 can generate corresponding references for each asset management system 110 to the analytics platform 130, and then provide the references to the analytics platform 130 for use by the analytics platform 130 in retrieving the corresponding asset data for use in an analytics operation.

In some example embodiments, the field determination module 510 is configured to determine that one of the plurality of management data fields of an asset management system 110 is to be used to derive an analytics data field of multiple analytics platforms 130 based on the corresponding language construct of the management data field. The coupling module 520 can generate a reference to the management data field in the asset management system 110, and then provide the reference to the multiple analytics platforms 130 for use by the multiple analytics platforms 130 in retrieving the corresponding asset data of the management data field for use in an analytics operation of multiple analytics platforms 130.

In some example embodiments, the asset data comprises at least one of classification data of the corresponding one of the plurality of assets, hierarchy data of the corresponding one of the plurality of assets, and attribute data of the corresponding one of the plurality of assets. In some example embodiments, the classification data is used to derive an analytics field for the analytics platform, with the analytics field indicating a classification of the corresponding asset of the identified one of the plurality of management data fields. In some example embodiments, the hierarchy data is used to derive an analytics field for the analytics platform, with the analytics field indicating what is the corresponding asset of the identified one of the plurality of management data fields (e.g., an identification of the specific asset) or indicating one or more components of the corresponding asset of the identified one of the plurality of management data field. In this respect analytic fields for the analytics platform(s) 130 can be derived from the asset data of the asset management system(s) 110.

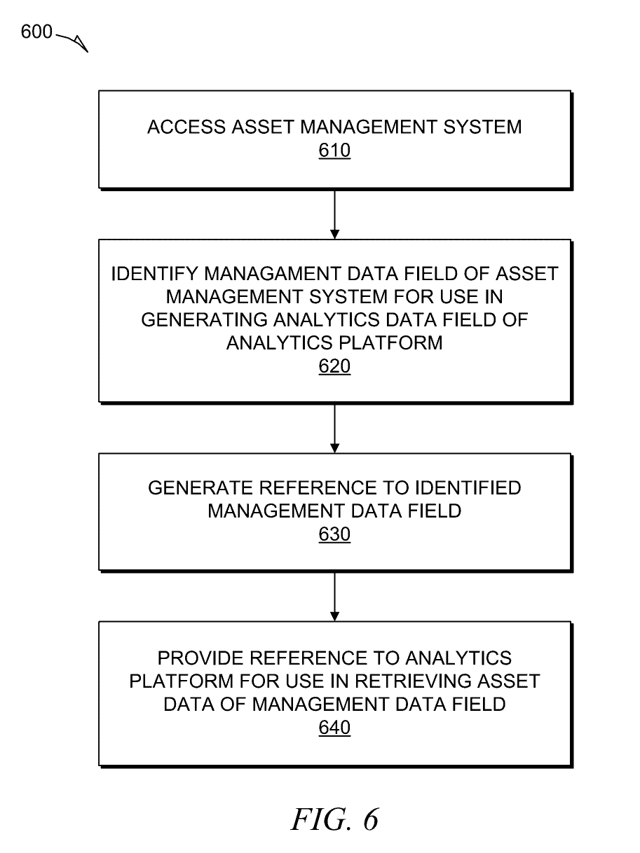

FIG. 6 is a flowchart illustrating a method 600, in accordance with some example embodiments, for coupling an asset management system with an analytics platform. Method 600 can be performed by processing logic that can comprise hardware (e.g., circuitry, dedicated logic, programmable logic, microcode, etc.), software (e.g., instructions run on a processing device), or a combination thereof. In one implementation, the method 600 is performed by the coupling system 200 of FIG. 2, or any combination of one or more of its modules, as described above.

At operation 610, one or more asset management systems 110 are accessed. The asset management system(s) 110 can store corresponding asset data for each one of a plurality of assets, with each corresponding asset data being stored in a corresponding one of a plurality of management data fields, and each one of the plurality of management data fields having a corresponding language construct. At operation 620, one of the first plurality of management data fields is identified, or otherwise determined, based on the corresponding language construct of the identified one of the first plurality of management data fields. At operation 630, a first reference to the identified one of the first plurality of management data fields is generated based on the identification of the one of the first plurality of management data fields. At operation 640, the first reference is provided to one or more analytics platform(s) 130 for use by the analytics platform(s) 130 in retrieving the corresponding asset data of the identified one of the first plurality of management data fields for use in one or more analytics operations of the analytics platform(s) 130.

Any combination of one or more of operations 610, 620, 630, and 640 can be performed in response to an indication that the asset management system(s) 110 has been updated. It is contemplated that any of the other features described within the present disclosure can be incorporated into method 600.

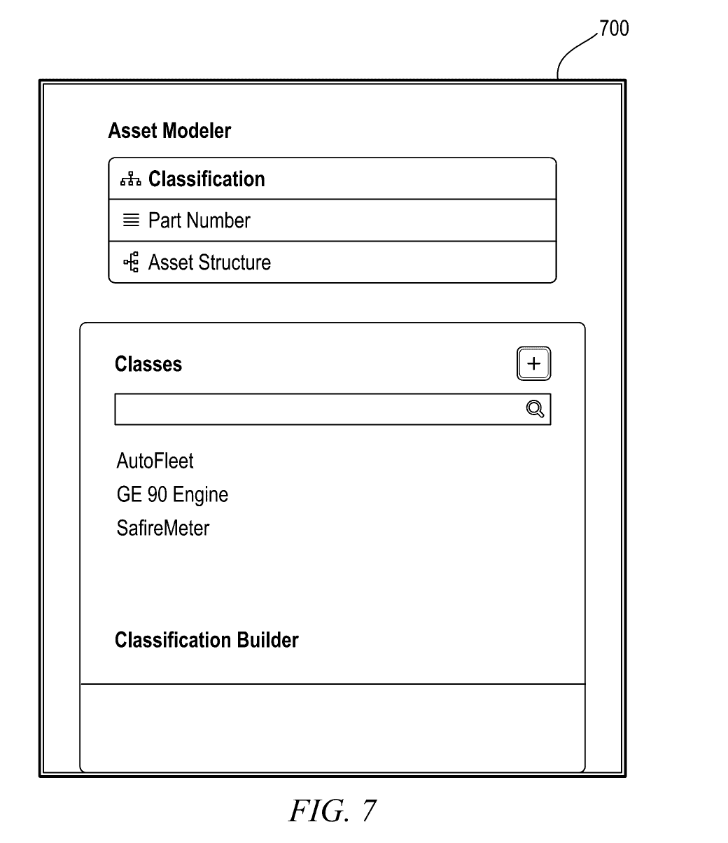

FIG. 7 illustrates a GUI 700 of an asset management system 110 displaying asset classifications, in accordance with some example embodiments. As seen in FIG. 7, the GUI 700 can be configured to enable a user 140 to define classifications (e.g., “AutoFleet”, “GE 90 Engine”, “SafireMeter”).

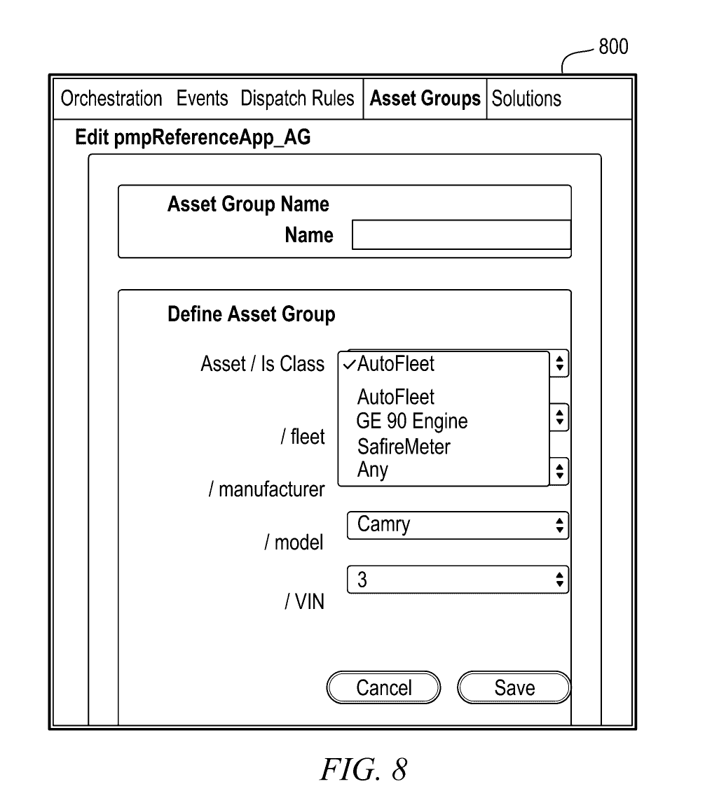

FIG. 8 illustrates a GUI 800 of an analytics platform 130 displaying an asset grouping field configured to enable a user 140 to group assets by classification, in accordance with some example embodiments. Given an example embodiment where classifications are defined in the asset management system 110, an “Asset/Is Class” field in the GUI 800 of the analytics platform 130 is an asset grouping field that enables the user 140 to group the assets by their classification. In one example embodiment, a solution is created in the analytics platform 130 with the “Asset/Is Class” field as part of a selector field set. In this example embodiment, based on an asset group being created in the analytics platform 130, the field values for the “Asset/Is Class” field will show the names of the classifications defined in the asset management system 110. The “Asset/Is Class” field can be mapped as an input to an analytics operation on the analytics platform 130 if the analytics operation needs to know the asset's classification during an orchestration run.

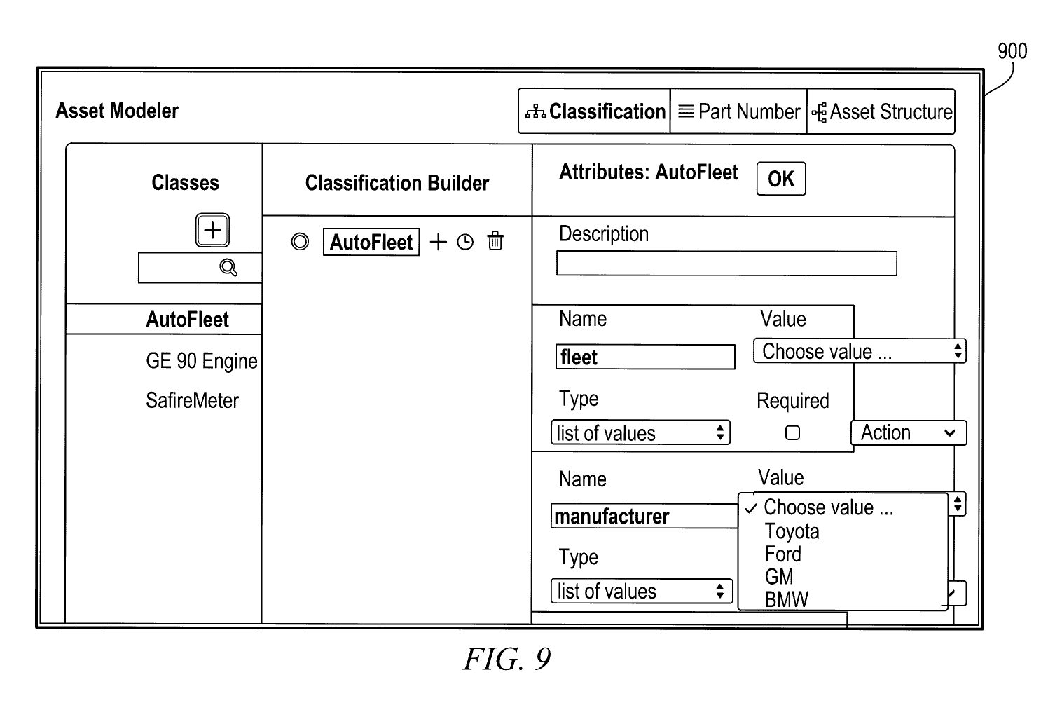

FIG. 9 illustrates a GUI 900 of an asset management system 110 displaying an asset classification having an attribute, in accordance with some example embodiments. The classification attribute of enumeration (“list of values”) type in the asset management system 110 is mapped to the analytics platform 130 as an asset grouping field. In the example embodiment of FIG. 9, the “AutoFleet” classification has an attribute named “manufacturer”. The “manufacturer” attribute is of type “list of values”, and the enumerated values are defined as “Toyota”, “Ford”, “GM”, and “BMW”.

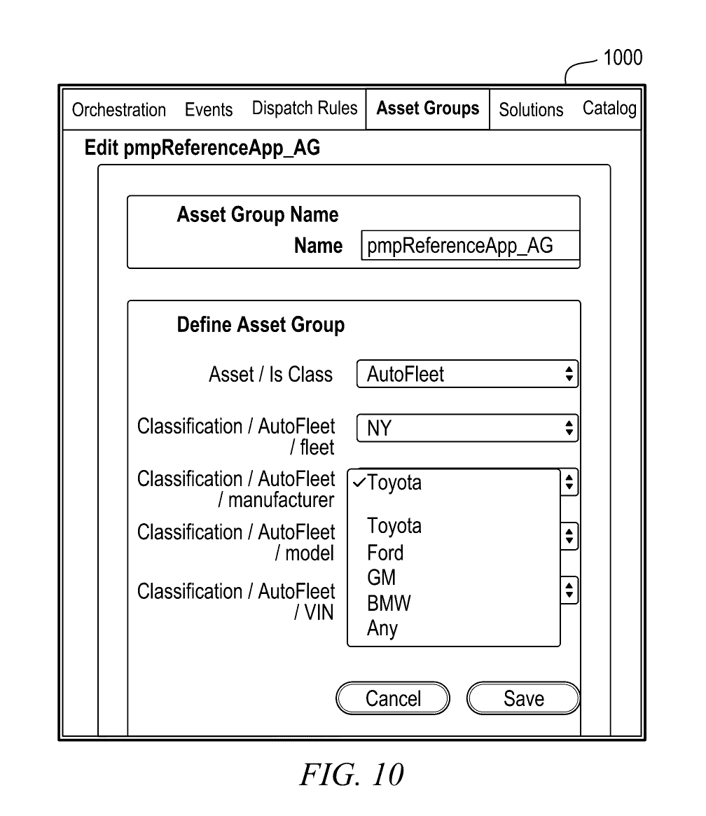

FIG. 10 illustrates a GUI 1000 of an analytics platform 130 displaying enumerated attribute values carried forward from an asset management system based on an asset group being created, in accordance with some example embodiments. In an example embodiment where a solution is created in the analytics platform 130 with an “Enumerable Attribute” field as part of a selector field set, when an asset group is created in the analytics platform 130, the field values for the “Enumerable Attribute” field will show the enumerated values (e.g., “Toyota”, “Ford”, “GM”, and “BMW”) defined in the asset management system 110. The “Enumerable Attribute” field can be mapped as an input or output of an analytics operation.

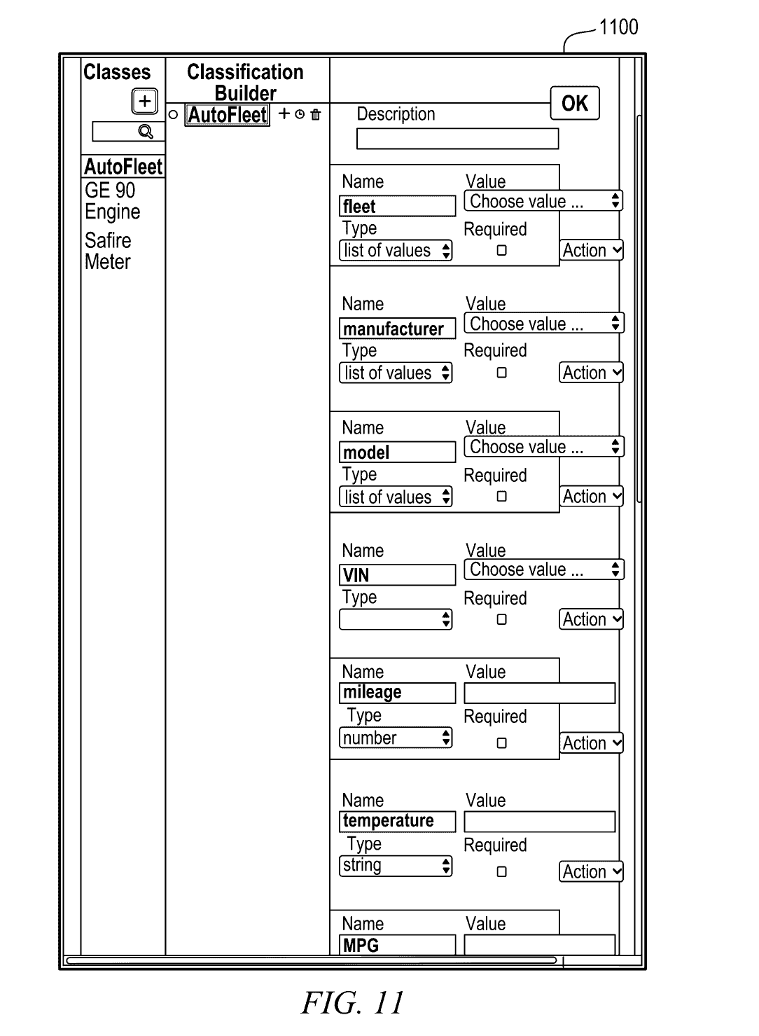

FIG. 11 illustrates a GUI 1100 of an asset management system 110 displaying non-enumerable attribute fields, in accordance with some example embodiments. The classification attribute of a type other than “list of values” in the asset management system 110 is mapped to the analytics platform 130 as a general field. In the example embodiment of FIG. 11, the “AutoFleet” classification has an attribute named “mileage” of type “number”.

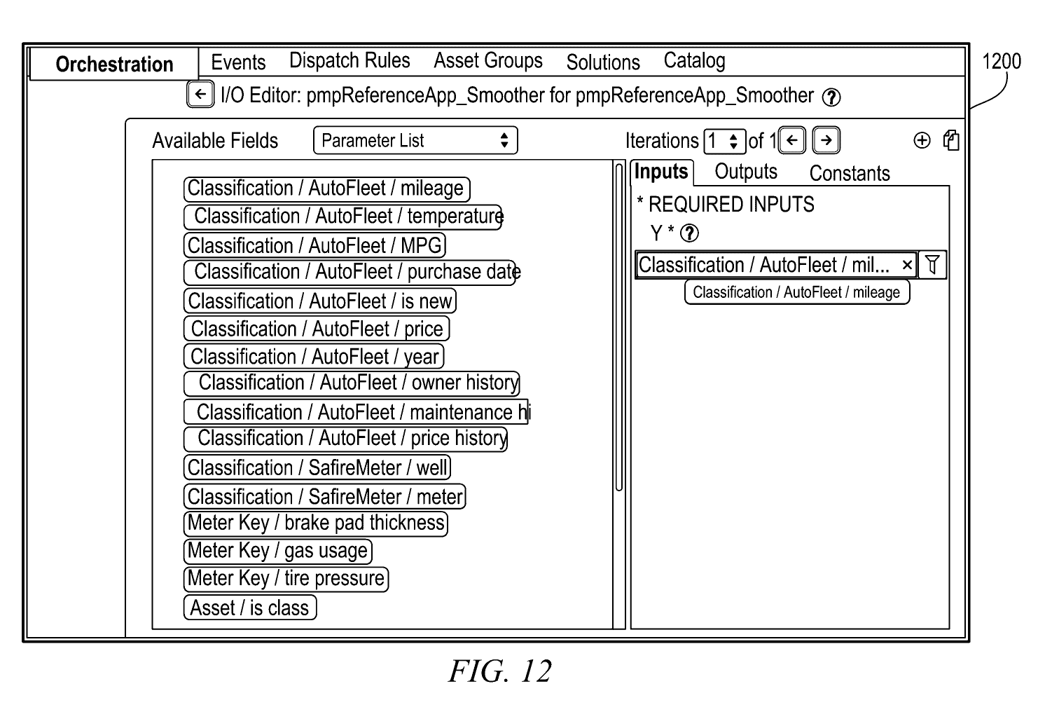

FIG. 12 illustrates a GUI 1200 of an analytics platform 130 displaying an attribute value defined in an asset management system 110 as part of an input/output mapping of an analytics operation, showing fields from the asset management system being carried forward into the analytics platform, in accordance with some example embodiments. In the example embodiment of FIG. 12, in an I/O editor of the analytics platform 130, when the input/output of an analytics operation is mapped, the “mileage” attribute defined in the asset management system 110 will be available as a “Classification/AutoFleet/mileage” field.

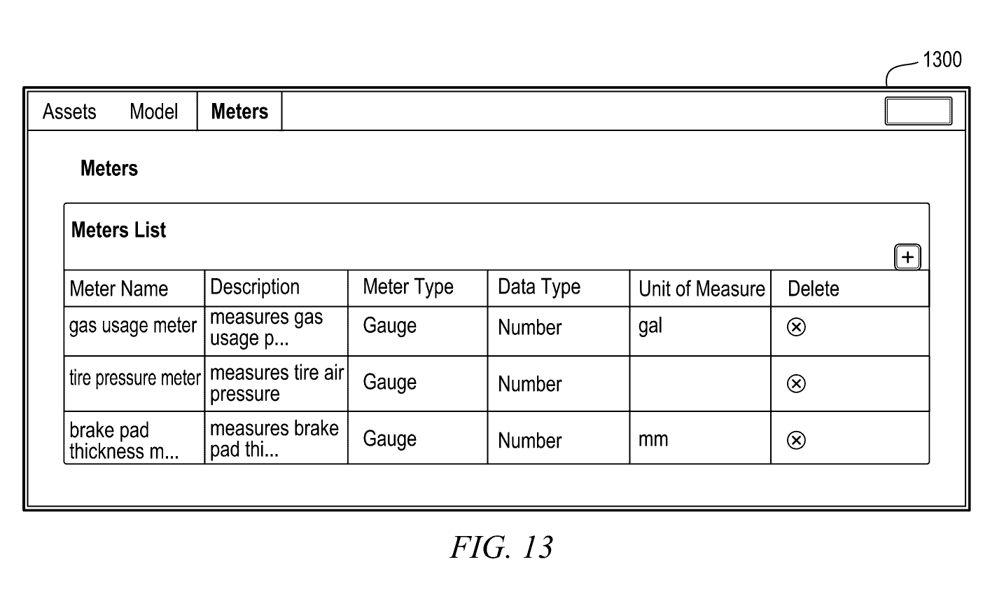

FIG. 13 illustrates a GUI 1300 of an asset management system 110 displaying meters to be used in defining the nature of time series data, in accordance with some example embodiments. In the asset management system 110, “Meters” can define the nature of the time series. The data type and unit of measure of a meter can indicate the type of the time series data and the unit it is in.

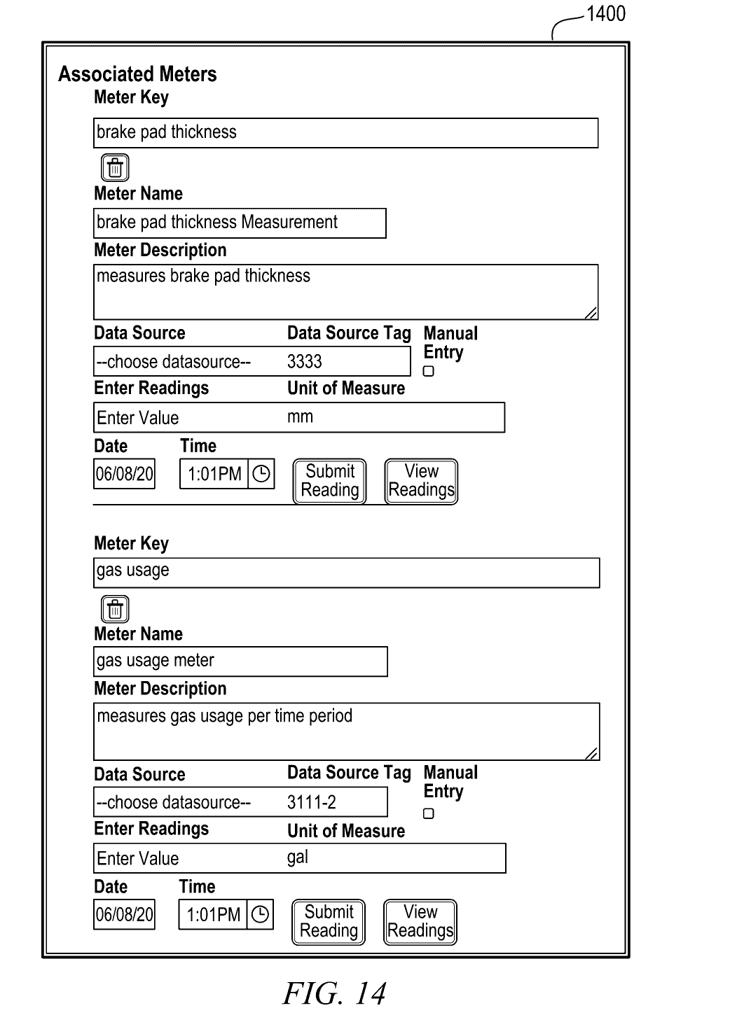

FIG. 14 illustrates a GUI 1400 of an asset management system 110 being used to associate meters with an asset, in accordance with some example embodiments. In some example embodiments, once the “Meters” are defined, the meters can be associated to the assets. In the example embodiments of FIG. 14, the Asset-to-Meter association is identified by “Meter Key”, and time series data is retrieved or stored using the “Meter Key” for the particular asset.

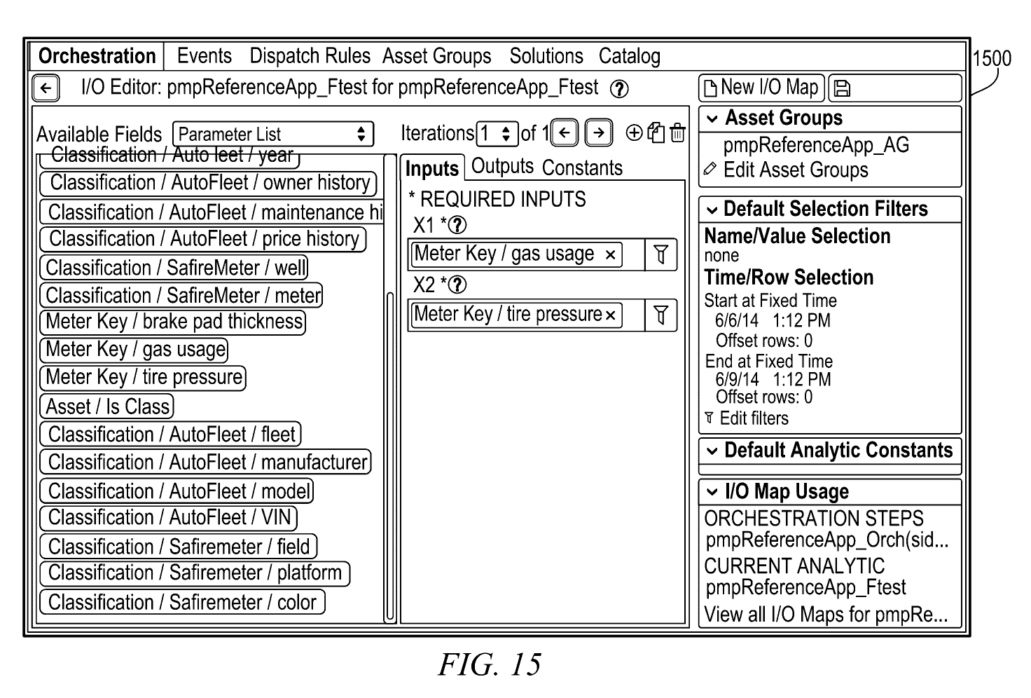

FIG. 15 illustrates a GUI 15000 of an analytics platform 130 displaying the availability in the analytics platform 130 of a meter key defined in the asset management system 110, where fields from the asset management system have been carried forward into the analytics platform, in accordance with some example embodiments.

The “Meter Key” in the asset management system 110 can be mapped to the analytics platform 130 as a general field. In the example embodiment of FIG. 14, the asset shown has a meter key named “gas usage”. In the I/O editor of the analytics platform 130, when the input/output of an analytics operation is mapped, the “gas usage” meter key defined in the asset management system 110 will be available as a “Meter Key/gas usage” field.

During an orchestration run, when the data is retrieved or stored for the analytics operation, a request may ask for the data in a specific unit. For example, for the “Meter Key/gas usage” field, the data can be stored in gallons (gal). However, the request may ask for the gas usage time series data in liters (L). In such cases, the coupling module 520 can perform the necessary conversion.

In some example embodiments, a time selection filter with no row offset is supported by the coupling system 120. During an orchestration run, when the data is retrieved for the analytics operation, a request may ask to filter the data being returned.

### Example Mobile Device

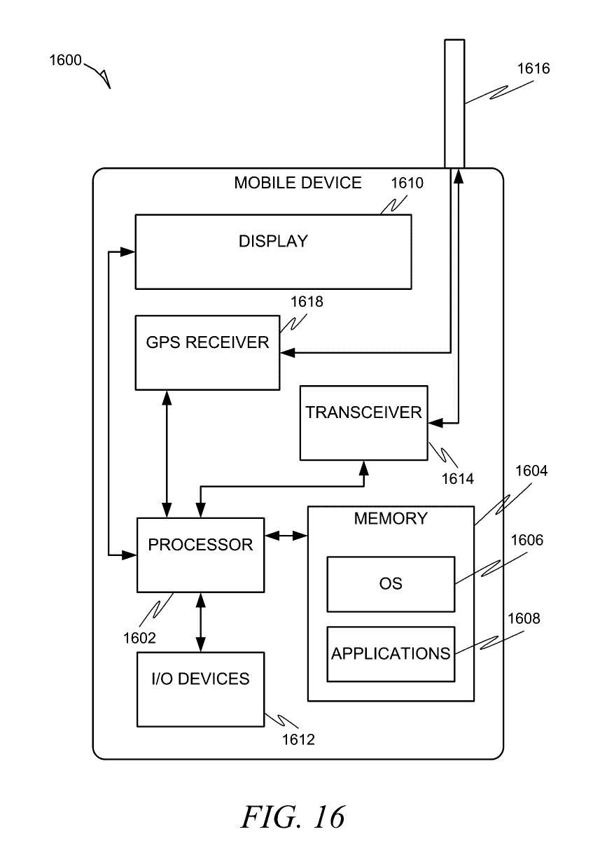

FIG. 16 is a block diagram illustrating a mobile device 1600, according to an example embodiment. The mobile device 1600 can include a processor 1602. The processor 1602 can be any of a variety of different types of commercially available processors suitable for mobile devices 1600 (for example, an XScale architecture microprocessor, a Microprocessor without Interlocked Pipeline Stages (MIPS) architecture processor, or another type of processor). A memory 1604, such as a random access memory (RAM), a Flash memory, or another type of memory, is typically accessible to the processor 1602. The memory 1604 can be adapted to store an operating system (OS) 1606, as well as application programs 1608, such as a mobile location enabled application that can provide location based services (LBSs) to a user. The processor 1602 can be coupled, either directly or via appropriate intermediary hardware, to a display 1610 and to one or more input/output (I/O) devices 1612, such as a keypad, a touch panel sensor, a microphone, and the like. Similarly, in some example embodiments, the processor 1602 can be coupled to a transceiver 1614 that interfaces with an antenna 1616. The transceiver 1614 can be configured to both transmit and receive cellular network signals, wireless data signals, or other types of signals via the antenna 1616, depending on the nature of the mobile device 1600. Further, in some configurations, a GPS receiver 1618 can also make use of the antenna 1616 to receive GPS signals.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the network 104 of FIG. 1) and via one or more appropriate interfaces (e.g., APIs).

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

A computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

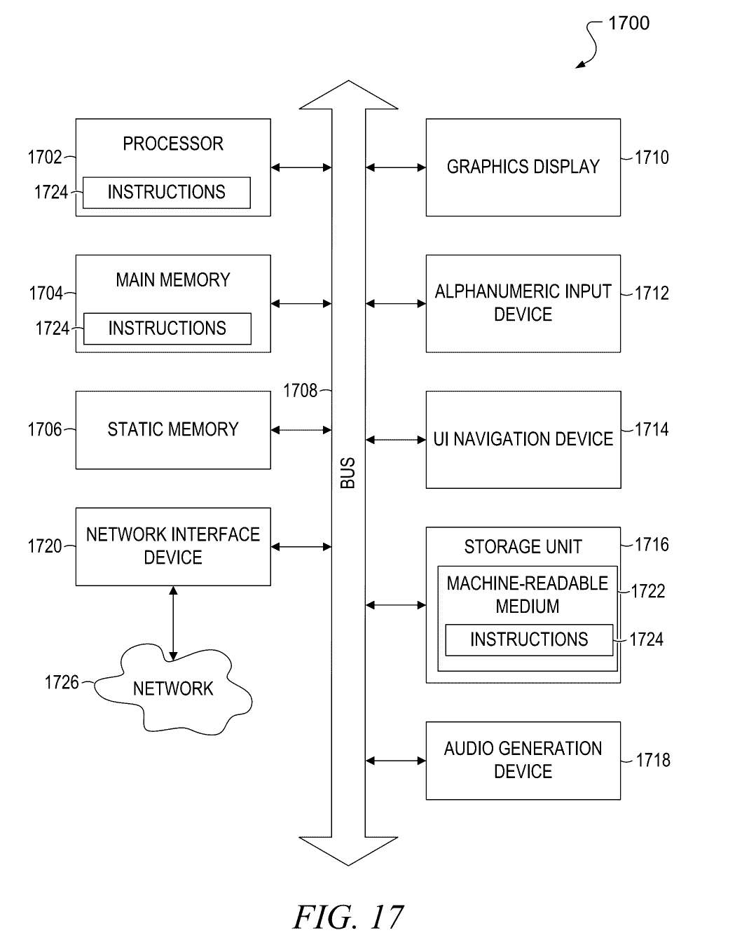

FIG. 17 is a block diagram of a machine in the example form of a computer system 1700 within which instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1700 includes a processor 1702 (e.g., a central processing unit (CPU), a graphics processing unit (GPU) or both), a main memory 1704 and a static memory 1706, which communicate with each other via a bus 1708. The computer system 1700 may further include a graphics or video display unit 1710 (e.g., a liquid crystal display (LCD) or a cathode ray tube (CRT)). The computer system 1700 also includes an alphanumeric input device 1712 (e.g., a keyboard), a user interface (UI) navigation (or cursor control) device 1714 (e.g., a mouse), a storage unit (e.g., a disk drive unit) 1716, an audio or signal generation device 1718 (e.g., a speaker), and a network interface device 1720.

### Machine-Readable Medium

The storage unit 1716 includes a machine-readable medium 1722 on which is stored one or more sets of data structures and instructions 1724 (e.g., software) embodying or utilized by any one or more of the methodologies or functions described herein. The instructions 1724 may also reside, completely or at least partially, within the main memory 1704 and/or within the processor 1702 during execution thereof by the computer system 1700, the main memory 1704 and the processor 1702 also constituting machine-readable media. The instructions 1724 may also reside, completely or at least partially, within the static memory 1706.

While the machine-readable medium 1722 is shown in an example embodiment to be a single medium, the term “machine-readable medium” may include a single medium or multiple media (e.g., a centralized or distributed database, and/or associated caches and servers) that store the one or more instructions 1724 or data structures. The term “machine-readable medium” shall also be taken to include any tangible medium that is capable of storing, encoding or carrying instructions for execution by the machine and that cause the machine to perform any one or more of the methodologies of the present embodiments, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and compact disc-read-only memory (CD-ROM) and digital versatile disc (or digital video disc) read-only memory (DVD-ROM) disks.

### Transmission Medium

The instructions 1724 may further be transmitted or received over a communications network 1726 using a transmission medium. The instructions 1724 may be transmitted using the network interface device 1720 and any one of a number of well-known transfer protocols (e.g., HTTP). Examples of communication networks include a LAN, a WAN, the Internet, mobile telephone networks, POTS networks, and wireless data networks (e.g., WiFi and WiMax networks). The term “transmission medium” shall be taken to include any intangible medium capable of storing, encoding, or carrying instructions for execution by the machine, and includes digital or analog communications signals or other intangible media to facilitate communication of such software.

Each of the features and teachings disclosed herein can be utilized separately or in conjunction with other features and teachings to provide a system and method for selective gesture interaction using spatial volumes. Representative examples utilizing many of these additional features and teachings, both separately and in combination, are described in further detail with reference to the attached figures. This detailed description is merely intended to teach a person of skill in the art further details for practicing preferred aspects of the present teachings and is not intended to limit the scope of the claims. Therefore, combinations of features disclosed above in the detailed description may not be necessary to practice the teachings in the broadest sense, and are instead taught merely to describe particularly representative examples of the present teachings.

Some portions of the detailed descriptions herein are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the below discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may include a general purpose computer selectively activated or reconfigured by a computer program stored in the computer. Such a computer program may be stored in a computer readable storage medium, such as, but is not limited to, any type of disk, including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The example methods or algorithms presented herein are not inherently related to any particular computer or other apparatus. Various general purpose systems, computer servers, or personal computers may be used with programs in accordance with the teachings herein, or it may prove convenient to construct a more specialized apparatus to perform the required method steps. The required structure for a variety of these systems will appear from the description below. It will be appreciated that a variety of programming languages may be used to implement the teachings of the disclosure as described herein.

Moreover, the various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of original disclosure, as well as for the purpose of restricting the claimed subject matter. It is also expressly noted that the dimensions and the shapes of the components shown in the figures are designed to help to understand how the present teachings are practiced, but not intended to limit the dimensions and the shapes shown in the examples.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A computer-implemented method comprising:
accessing a first asset management system, the first asset management system storing corresponding asset data for each one of a first plurality of assets, each corresponding asset data being stored in a corresponding one of a first plurality of management data fields, each one of the first plurality of management data fields having a corresponding language construct;
identifying, by a machine having a memory and at least one processor, one of the first plurality of management data fields based on the corresponding language construct of the identified one of the first plurality of management data fields;
generating, based on the identifying of the one of the first plurality of management data fields, a first reference to the identified one of the first plurality of management data fields; and
providing the first reference to a first analytics platform for use by the first analytics platform in retrieving the corresponding asset data of the identified one of the first plurality of management data fields for use in a first analytics operation of the first analytics platform.

2. The computer-implemented method of claim 1, further comprising causing an auto-population of a selectable graphical user interface (GUI) element of the first analytics platform with the corresponding asset data of the identified one of the first plurality of management data fields based on the first reference, enabling a user to select the identified one of the first plurality of management data fields for use in the first analytics operation of the first analytics platform.

3. The computer-implemented method of claim 1, wherein the first reference is configured to be used to modify a value of the identified one of the first plurality of management data fields based on output data of the first analytics operation.

4. The computer-implemented method of claim 1, further comprising receiving an indication that the first asset management system has been updated, wherein the identifying and the generating are performed based on the indication.

5. The computer-implemented method of claim 1, further comprising:
accessing a second asset management system distinct from the first asset management system, the second asset management system storing corresponding asset data for each one of a second plurality of assets, each corresponding asset data being stored in a corresponding one of a second plurality of management data fields, each one of the second plurality of management data fields having a corresponding language construct;
identifying one of the second plurality of management data fields based on the corresponding language construct of the identified one of the second plurality of management data fields;
generating, based on the identifying of the one of the second plurality of management data fields, a second reference to the identified one of the second plurality of management data fields; and
providing the second reference to the first analytics platform for use by the first analytics platform in retrieving the corresponding asset data of the identified one of the second plurality of management data fields for use in the first analytics operation of the first analytics platform.

6. The computer-implemented method of claim 1, further comprising:
identifying another one of the first plurality of management data fields based on the corresponding language construct of the other one of the first plurality of management data fields;
generating, based on the identifying of the other one of the first plurality of management data fields, a second reference to the identified one of the first plurality of management data fields; and
providing the second reference to a second analytics platform for use by the second analytics platform in retrieving the corresponding asset data of the identified other one of the first plurality of management data fields for use in a second analytics operation of the second analytics platform.

7. The computer-implemented method of claim 1, wherein each of the corresponding asset data comprises at least one of classification data of the corresponding one of the first plurality of assets, hierarchy data of the corresponding one of the first plurality of assets, and attribute data of the corresponding one of the first plurality of assets.

8. The computer-implemented method of claim 7, wherein the classification data is used to derive an analytics field for the first analytics platform, the analytics field indicating a classification of the corresponding asset of the identified one of the first plurality of management data fields.

9. The computer-implemented method of claim 7, wherein the hierarchy data is used to derive an analytics field for the first analytics platform, the analytics field indicating what is the corresponding asset of the identified one of the first plurality of management data fields or one or more components of the corresponding asset of the identified one of the first plurality of management data field.

10. A system comprising:
a machine having at least one module, the at least one module comprising at least one processor and being configured to perform operations comprising:
accessing a first asset management system, the first asset management system storing corresponding asset data for each one of a first plurality of assets, each corresponding asset data being stored in a corresponding one of a first plurality of management data fields, each one of the first plurality of management data fields having a corresponding language construct;
identifying one of the first plurality of management data fields based on the corresponding language construct of the identified one of the first plurality of management data fields;
generating, based on the identifying of the one of the first plurality of management data fields, a first reference to the identified one of the first plurality of management data fields; and
providing the first reference to a first analytics platform for use by the first analytics platform in retrieving the corresponding asset data of the identified one of the first plurality of management data fields for use in a first analytics operation of the first analytics platform.

11. The system of claim 10, wherein the operations further comprise causing an auto-population of a selectable graphical user interface (GUI) element of the first analytics platform with the corresponding asset data of the identified one of the first plurality of management data fields based on the first reference, enabling a user to select the identified one of the first plurality of management data fields for use in the first analytics operation of the first analytics platform.

12. The system of claim 10, wherein the first reference is configured to be used to modify a value of the identified one of the first plurality of management data fields based on output data of the first analytics operation.

13. The system of claim 10, wherein the operations further comprise receiving an indication that the first asset management system has been updated, wherein the identifying and the generating are performed based on the indication.

14. The system of claim 10, wherein the operations further comprise:
accessing a second asset management system distinct from the first asset management system, the second asset management system storing corresponding asset data for each one of a second plurality of assets, each corresponding asset data being stored in a corresponding one of a second plurality of management data fields, each one of the second plurality of management data fields having a corresponding language construct;
identifying one of the second plurality of management data fields based on the corresponding language construct of the identified one of the second plurality of management data fields;
generating, based on the identifying of the one of the second plurality of management data fields, a second reference to the identified one of the second plurality of management data fields; and
providing the second reference to the first analytics platform for use by the first analytics platform in retrieving the corresponding asset data of the identified one of the second plurality of management data fields for use in the first analytics operation of the first analytics platform.

15. The system of claim 10, wherein the operations further comprise:
identifying another one of the first plurality of management data fields based on the corresponding language construct of the other one of the first plurality of management data fields;
generating, based on the identifying of the other one of the first plurality of management data fields, a second reference to the identified one of the first plurality of management data fields; and
providing the second reference to a second analytics platform for use by the second analytics platform in retrieving the corresponding asset data of the identified other one of the first plurality of management data fields for use in a second analytics operation of the second analytics platform.

16. The system of claim 10, wherein each of the corresponding asset data comprises at least one of classification data of the corresponding one of the first plurality of assets, hierarchy data of the corresponding one of the first plurality of assets, and attribute data of the corresponding one of the first plurality of assets.

17. The system of claim 16, wherein the classification data is used to derive an analytics field for the first analytics platform, the analytics field indicating a classification of the corresponding asset of the identified one of the first plurality of management data fields.

18. The system of claim 16, wherein the hierarchy data is used to derive an analytics field for the first analytics platform, the analytics field indicating what is the corresponding asset of the identified one of the first plurality of management data fields or one or more components of the corresponding asset of the identified one of the first plurality of management data field.

19. A non-transitory machine-readable storage medium, tangibly embodying a set of instructions that, when executed by at least one processor, causes the at least one processor to perform operations comprising:
accessing a first asset management system, the first asset management system storing corresponding asset data for each one of a first plurality of assets, each corresponding asset data being stored in a corresponding one of a first plurality of management data fields, each one of the first plurality of management data fields having a corresponding language construct;
identifying one of the first plurality of management data fields based on the corresponding language construct of the identified one of the first plurality of management data fields;
generating, based on the identifying of the one of the first plurality of management data fields, a first reference to the identified one of the first plurality of management data fields; and
providing the first reference to a first analytics platform for use by the first analytics platform in retrieving the corresponding asset data of the identified one of the first plurality of management data fields for use in a first analytics operation of the first analytics platform.

20. The non-transitory machine-readable storage medium of claim 19, wherein the operations further comprise causing an auto-population of a selectable graphical user interface (GUI) element of the first analytics platform with the corresponding asset data of the identified one of the first plurality of management data fields based on the first reference, enabling a user to select the identified one of the first plurality of management data fields for use in the first analytics operation of the first analytics platform.
